(19) United States
(12) Patent Application Publication
(10) Pub. No.: US 2020/0110868 A1
(43) Pub. Date: Apr. 9, 2020

(54) AUGMENTED PUSH AUTHENTICATION

(71) Applicant: CA, Inc., New York, NY (US)

(72) Inventors: Jeetendra Gopal Varanjani, Hyderabad (IN); Chandra Sekhar Varanasi, Hyderabad (IN); Murali Krishna Segu, Hyderabad (IN); Vinay Kumar Tiruvaipeta, Hyderabad (IN)

(21) Appl. No.: 16/155,440

(22) Filed: Oct. 9, 2018

(51) Int. Cl. G06F 21/44; H04L 29/08; H04L 29/06; G06F 21/32

(52) U.S. Cl. CPC G06F 21/44; H04L 67/26; G06F 2221/2103; G06F 21/32; H04L 63/0876

(57) ABSTRACT

To increase the effectiveness of push authentication, a push authentication can be augmented with another authentication factor. A push authentication can be augmented with the “what you know” factor, effectively merging the “what you know” factor into the “what you have” factor. Using a collection of “what you know” factor queries (e.g., knowledge-based questions), an authentication server can select a subset of the “what you know” factor queries and incorporate the selected one or more factor queries into a message that conveys the push authentication notification.

### BACKGROUND

The disclosure generally relates to the field of information security, and more particularly to generic control systems or specific applications.

Multifactor authentication systems increase security of the user authentication process by requiring a user requesting access to an application to first present multiple types of credentials. Credentials are verified before the user is granted access to the application. Requested credentials belong to different categories of authentication factors. A service provider can set an assurance level that is associated with a set of credentials required to access an application.

An identity provider presents a client with a credential to collect from the user. The client collects the corresponding credential from the user and submits the credential to the identity provider. The identity provider sends the user credential to a provider associated with the credential type for verification. This process repeats for each of the credential types designated by the service provider assurance level. The user request to access the application is granted upon successful verification of each credential.

### BRIEF DESCRIPTION OF THE DRAWINGS

Embodiments of the disclosure may be better understood by referencing the accompanying drawings.

FIG. 1 is a conceptual diagram of augmented push authentication. A user or program often attempts to access a protected resource (e.g., an account, a file, an object, a web application, etc.) that is accessible over a network.

FIG. 2 is a diagram of a registered device with an example of a user interface presenting an augmented push authentication.

FIG. 3 is a flowchart of example operations for generating an augmented push authentication.

FIG. 4 is a flowchart of example operations for generating an augmented push authentication that can reduce resolution of answers.

FIG. 5 depicts an example computer system with an augmented push authentication server.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Introduction

The United States National Institute for Standards and Technology (U.S. NIST) updated its guidelines in 2013 to indicate that out-of-band short message service (SMS) messages have a higher risk of security vulnerability (e.g., being intercepted or redirected) than out-of-band push authentication. Out-of-band push authentication is a secondary factor in a multi-factor authentication (MFA) security mechanism. For out-of-band (OOB) push authentication, a push notification is sent to a registered device when a login request is made. The push notification requests user input to approve or deny the login. Thus, push-authentication can be considered a “what you have” factor since it requires possession of the registered device.

Although push authentication is considered more secure than other authentication methods, security risks still exist. Weaknesses in push authentication arise from user behavior and device security. User's can develop a habit of clicking on notifications reflexively even with as little as two security related notifications. This reflex may approve a fraudulent push authentication notification. With respect to device security, push authentication relies on security measures of the device itself (e.g., biometric authentication to access the registered device). If a registered device is lost or stolen and can be accessed by a bad actor, then the bad actor can respond to the push authentication notification. In addition, a user may possess a device that is compromised. A bad actor can install a malicious agent on the compromised device to automatically approve a push authentication notification.

Overview

To increase the effectiveness of push authentication, a push authentication can be augmented with another authentication factor. A push authentication can be augmented with the “what you know” factor, effectively merging the “what you know” factor into the “what you have” factor. Using a collection of “what you know” factor queries (e.g., knowledge-based questions), an authentication server can select a subset of the “what you know” factor queries and incorporate the selected one or more factor queries into a message that conveys the push authentication notification.

Example Illustrations

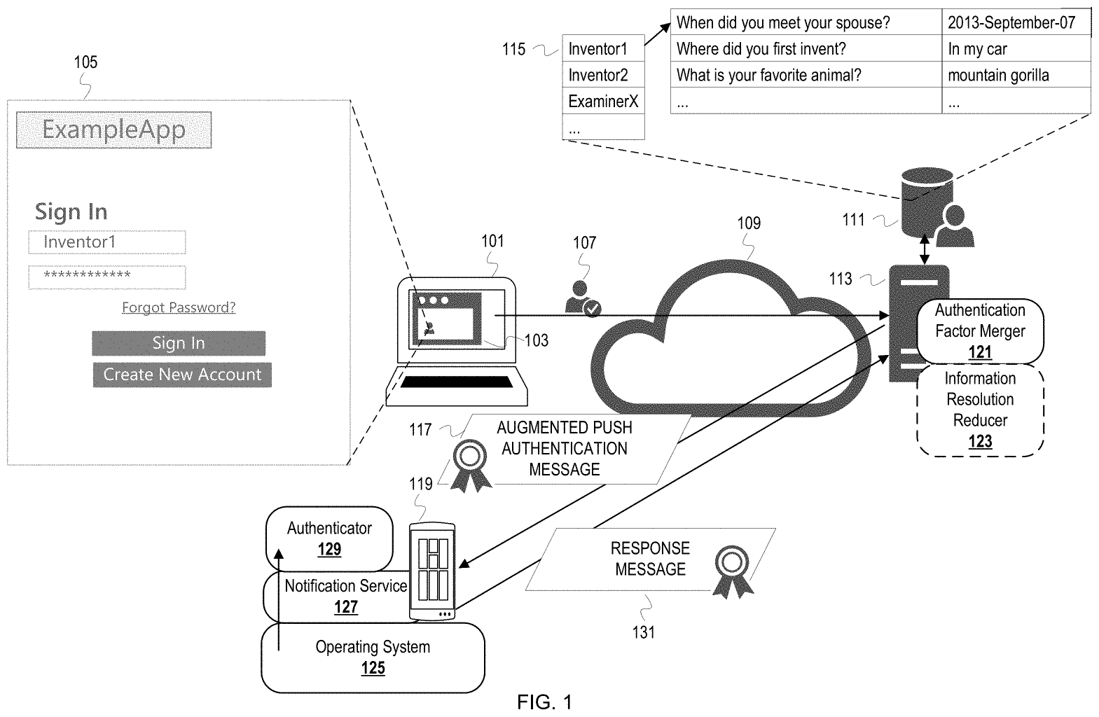

FIG. 1 is a conceptual diagram of augmented push authentication. A user or program often attempts to access a protected resource (e.g., an account, a file, an object, a web application, etc.) that is accessible over a network. A protected resource is not often referred to a as a cloud asset or a cloud-based application or service. In FIG. 1, a user interface 103 of an application displayed on a computer 101 presents a login screen 105 to access a protected resource. An authentication server 113 (e.g., a hardware or software server) can be a component of the application, a third-party service associated with the application, etc. For this illustration, the protected resource has been previously configured to require push authentication when access is attempted. For an account associated with a user identifier or credential “Inventor1,” a mobile device 119 has been previously registered for the push authentication.

When login credentials 107 (e.g., username and password) are submitted, the application or application component underlying the user interface 103 communicates the credentials 107 via a network 109 to the authentication server 113 for authentication. The authentication server 113 determines that augmented push authentication has been indicated for the protected resource. This may be globally set for all protected resources associated with the authentication server, a default setting for the application, etc. In the case of the authentication server 113 performing authentication for multiple protected resources (e.g., different web applications), the authentication server 113 may access a data structure with settings or configuration data indicating the specific multi-factor authentication mechanism to apply for the protected resource, including augmented push authentication. After determining that augmented push authentication is enabled for the protected resource, the authentication server 113 accesses an account entry in a user/account repository 111 based on the credentials 107. For this illustration, the repository 111 includes entries for Inventor1, “Inventor2,” and “ExaminerX.” The authentication server 113 determines that a plurality of questions have been specified for Inventor1 and selects from these questions. Configuration data can indicate how many questions are to be selected and included for augmented push authentication. Assuming a single question is selected, the authentication server 113 may cache the question and corresponding correct answer for the authentication session to verify a response.

The authentication server 113 includes an authentication factor merger 121 and an information resolution reducer 123 which participate in constructing a push message for the augmented push authentication. These components can be plug-ins or extensions to an authentication server, incorporated into code of an authentication server, etc. The authentication factor merger 121 constructs the push message depending upon how configuration data indicates the answer(s) is to be collected (e.g., text field, selection of a graphical button, selection of a radio, etc.). Configuration data also indicates how the push message question(s) is to be presented. The configuration data can be program code that includes a function call previously published or defined by the target application that will present the authentication notification message and/or user interface and message parameters parsed by the target application to update a user interface and interact with an operating system of the registered device for graphical elements. If the configuration data indicates that the correct answer is to be selected (e.g., from a set of graphical buttons), then the authentication factor merger 121 determines incorrect answers for the selected question. They may be previously defined or generated on-the-fly for inclusion in the push notification message. The authentication factor merger 121 or another component may generate incorrect answers based on processing the questions. For instance, the authentication server 113 can evaluate the question to determine whether a relatively small set of answers are possible (e.g., date based question or geographic location based question). For some questions, the authentication server 113 may submit the question to a web service or search engine and select responses as a basis for the incorrect answers. Embodiments may generate the incorrect answers based on the correct answer. As an example, the authentication factor merger 121 can apply natural language processing to the correct answer, classify the correct answer, and select alternatives within the same class. The authentication factor merger 121 may randomly select incorrect answers from the same class as the correct answer.

Embodiments can also present the correct answer at a lower resolution and incorrect answers at that same resolution. An information resolution reducer 123 can determine a resolution level for presenting the correct answer and determine the correct answer at the lower resolution level or lower resolution representation of the correct answer. For example, a correct answer may be a date. The information resolution reducer 123 reads configuration data or a setting to determine that the resolution level corresponds to indicating the day component of the date. The information resolution reducer 123 can then randomly select numbers within the range of numbers possible for a date that are not the correct day date.

The authentication server 113 constructs a payload from the information determined by the authentication factor merger 121 and the information resolution reducer 123, and constructs a message to carry the payload. Depending upon the particular security protocol being used for the push notification aspect of the push authentication, the authentication server also associates a security key or token with the constructed message to construct an augmented push authentication message 117. The authentication server validates responses to the message 117 with the token or security key.

The authentication server 113 then transmits the message 117 to the registered device 119, which processes the message 117. The registered device 119 will have a service of an operating system 125 that listens for messages. In FIG. 1, a notification service 127 is listening for notification messages. The notification service 127 generates a notification based on the message 117. If the message 117 identifies an application on the registered device 119 that is already open and running, then the notification service 127 communicates the message 117 or payload of the message 117 to the running application. If the application identified in the message 117 (e.g., in the message header) is not open on the device 119, then the notification service 127 causes a notification about the message 117 to be generated and displayed on the device 119. Assuming an authenticator 129 is the identified application, then the authenticator 129 processes the message 117 and generates or updates a user interface to present the knowledge-based question and answer collection element(s) (e.g., text box or buttons). The authenticator application 129 may be a part of an application “ExampleApp” corresponding to the login 105. The authenticator application 129 may be a third-party application (with respect to the application ExampleApp) with which the application ExampleApp has previously registered.

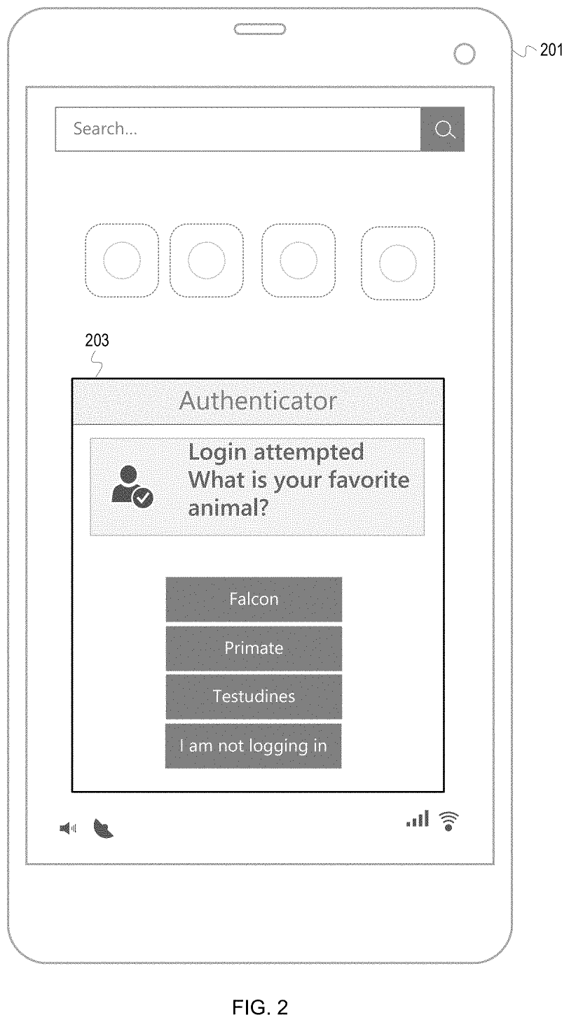

FIG. 2 is a diagram of a registered device with an example of a user interface presenting an augmented push authentication. A device 201 is depicted as a smartphone. The smartphone 201 includes a user interface 203 for the authenticator application 129. The user interface 203 presents an indication that a login has been attempted and presents the question selected by the authentication server 113, which in this example illustration is “What is your favorite animal?” The user interface 203 presents answers at a lower resolution than the correct answer in the account entry retrieved from repository 111. The answer to the selected question in the repository is “mountain gorilla.” The user interface 203 presents as choices for the augmented push authentication: Falcon, Primate, and Testudines. In addition, the user interface 203 presents an option of “I am not logging in” as the selection to report a fraudulent login attempt.

Based on a selection in the user interface 203, the device 119 returns a response message 131. The response message 131 should include the token or security conveyed in the message 117 to allow the authentication server 113 to validate the response message 131.

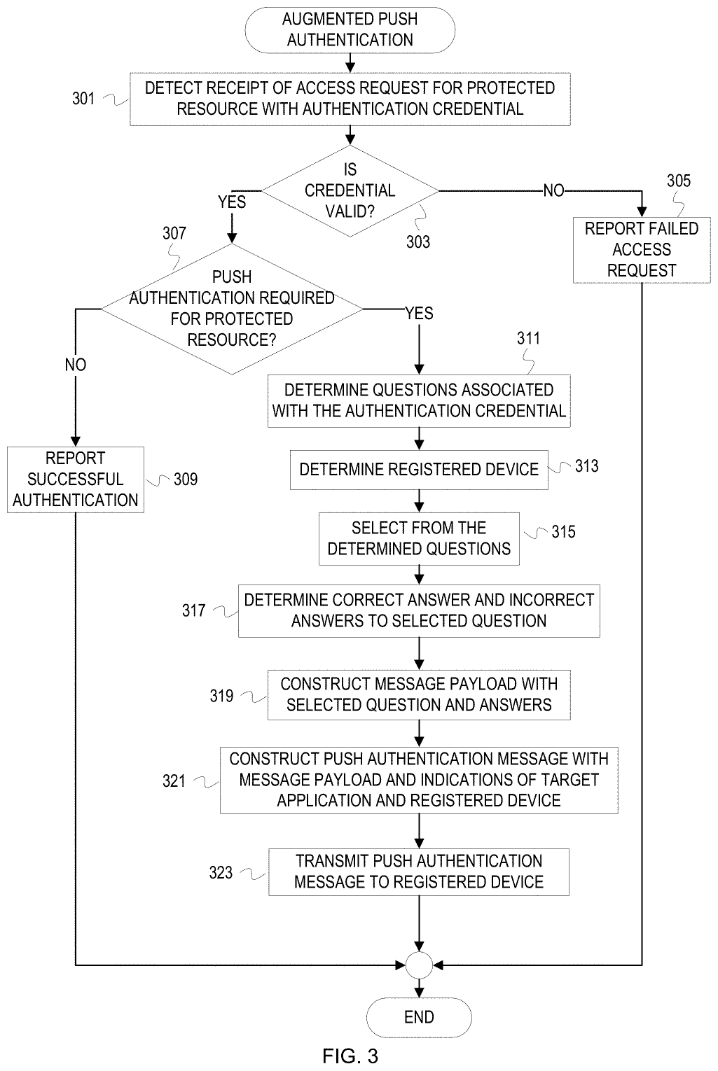

FIG. 3 is a flowchart of example operations for generating an augmented push authentication. The example operations refer to an authentication server as performing the example operations for consistency with FIG. 1.

The authentication server accepts requests to access a protected resource and at some point detects receipt of an access request for the protected resource (301). The access request for the protected resource may be an account login for a web application, a request to retrieve an object or file, a request to read information from a blog, etc. The authentication credential is a credential that would be associated with the protected resource and presumably authorized to access the protected resource. For example, the credential may be a username or account identifier.

The authentication server determines whether the credential is valid (303). The credential may be determined as valid based on the combination of the credential and another credential (e.g., username and password combination). In some cases, a valid credential may be deemed valid based on its existence in a repository of accounts associated with a protected resource. If the credential is not valid, then the authentication server reports the failed access request (305). This may be a return notification of the failure, logging the failure, etc.

If the credential is determined to be valid (303), then the authentication server determines whether push authentication is required for the protected resource (307). This can be indicated for the protected resources, as a setting in the authentication server, etc. For these example operations, the authentication server enforces augmented push authentication. Thus, a setting of push authentication is a setting for augmented push authentication. In some cases, an authentication server provides both push authentication and augmented push authentication. If push authentication is not required, then the authentication server reports a successful authentication (309).

If augmented push authentication is indicated for the protected resource (307), then the authentication server determines questions associated with the authentication credential (311). The questions and correct answer for each question would have been collected proximate with registration of the device for the augmented push authentication. The authentication server accesses a repository a store that hosts this information by account identifier or user identifier. In addition to the questions, the authentication server determines a device registered to receive the push notification (313). For example, a phone number may be specified. The authentication server then selects from the determined questions (315). Depending upon authentication parameters, the authentication server can select one or more of the questions. Due to expected space constraints, an augmented push authentication message would likely be formed with one question. Selection of the question can be random. The authentication server can use a random number generator (RNG) or quasi-RNG and modulo the randomly generated number to select a question based on index.

Based on the selected question, the authentication server determines a correct answer (i.e., answer provided for the question by a registered user) (317). The authentication server can mark the entry that associates the question and the answer to later validate a response, or cache the answer and the question. Since the authentication server can have multiple in-flight augmented push authentication messages, the authentication server may maintain data for each of the in-flight messages to eventual validation. If the authentication message will present options for selection, then the authentication server also determines incorrect answers to present.

The authentication server then constructs a message payload with the selected question (319). The authentication server creates message from a defined structure and populates fields with the selected question. If answers are to be presented, then the authentication server also populates the message payload with the correct answer and incorrect answers. The payload may be a body of a hypertext markup language file. The payload may be an object, such as a JavaScript Object Notation (JSON) object. The authentication server may also construct the payload with program code and/or display parameters that indicate how to present the augmented authentication message (e.g., graphical buttons, text field, order of presentation of answers, etc.). The program code and/or display parameters can be defined in configuration data of the authentication server, push authentication settings, application settings, etc. The authentication server may choose from multiple program code and/or display parameters corresponding to different platforms or environments of possible devices for the out-of-band push authentication.

The authentication server then constructs the push authentication message according to a communication protocol corresponding to the registered device (321). The communication protocol can be determined from an attribute or property of the device indicated with the identifier (e.g., phone number) of the device. The authentication server constructs the message to include the message payload and indications of a target application and the registered device. The target application is an application corresponding to the protected resource that will present the augmented push authentication message. The authentication server then transmits the augmented push authentication message to the registered device (323).

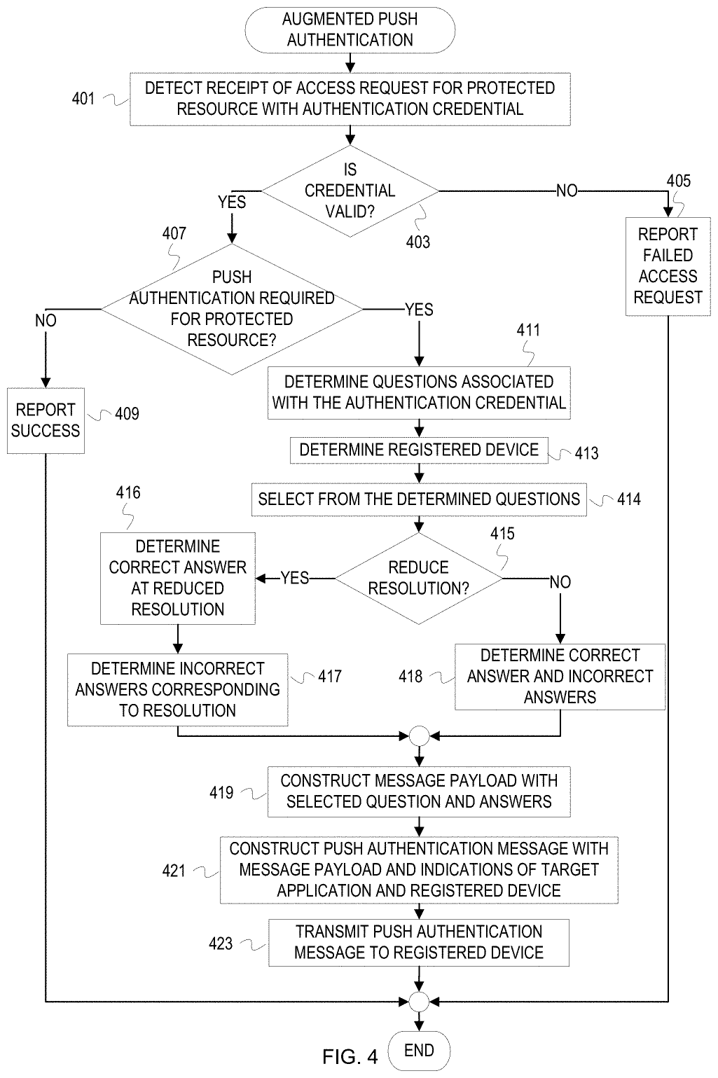

FIG. 4 is a flowchart of example operations for generating an augmented push authentication that can reduce resolution of answers. A privacy concern or privacy policy may specify that a collected answer not be visible in full resolution (e.g., a complete residential address). Augmented push authentication can still be implemented with answers to knowledge-based questions at a lower resolution. The example operations refer to an authentication server as performing the example operations for consistency with FIG. 1. The example operations in FIG. 4 are similar to the operations in FIG. 3. Differences relating to the reduced resolution of an answer occur in operations represented by blocks 415-417.

As in FIG. 3, operations effectively begin based upon the authentication server detecting receipt of an access request for a protected resource (401). The authentication server determines whether the credential is valid (403). If the credential is not valid, then the authentication server reports the failed access request (405). If the credential is determined to be valid (403), then the authentication server determines whether augmented push authentication is indicated for the protected resource (407). If push authentication is not required, then the authentication server reports a successful authentication (409).

If augmented push authentication is indicated for the protected resource (407), then the authentication server proceeds with the execution path for generating the augmented push authentication message. The authentication server determines questions associated with the authentication credential (411). The authentication server determines a device registered to receive the push notification (413). The authentication server then selects one or more questions from the determined questions (414). Based on the selected question, the authentication server determines a previously provided answer (“correct answer”). Although previously referred to as the correct answer, a user may provide an incorrect answer or fake data due to privacy concerns. Regardless, the provided answer is “correct” for purposes of authentication since that is the answer indicated by a user for authentication when creating an account with augmented push authentication or registering for push authentication.

After selection of a question(s), the authentication server determines whether reduced resolution is indicated for the correct answer (415). This indication may be a global setting to be applied across all answers, specified for types of questions and/or types of answers, or set for individual answers. If resolution reduction is not indicated for the selected question and/or corresponding answer, then the authentication server proceeds with determining the correct answer and incorrect answers (418).

If resolution reduction is indicated, then the authentication server determines the correct answer at the lower resolution (416). A lower resolution can be pre-defined and multiple resolutions may be defined. For example, the authentication server may further decrease resolution based on detecting a preceding failed authentication in a time window. The lower resolution correct answer can be pre-defined or dynamically determined. The authentication server can access a third-party service or source to dynamically determine the correct answer at the lower resolution. In addition, the authentication server determines incorrect answers at the same lower resolution as the lower resolution correct answer (417).

With the lower resolution answers (incorrect and correct), the authentication server constructs a message payload with the selected question (419). The authentication server then constructs the push authentication message according to a communication protocol corresponding to the registered device (421). The communication protocol can be determined from an attribute or property of the device indicated with the identifier (e.g., phone number) of the device. The authentication server constructs the message to include the message payload and indications of a target application and the registered device. The target application is an application corresponding to the protected resource that will present the augmented push authentication message. The authentication server then transmits the augmented push authentication message to the registered device (423).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. With respect to FIG. 3, the questions (311) and registered device (313) can be determine in a single access of a respository associated with the authentication credential. In some cases, the registered device and attributes of that device (e.g., platform or operating system) is determined to influence selection of display parameters. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

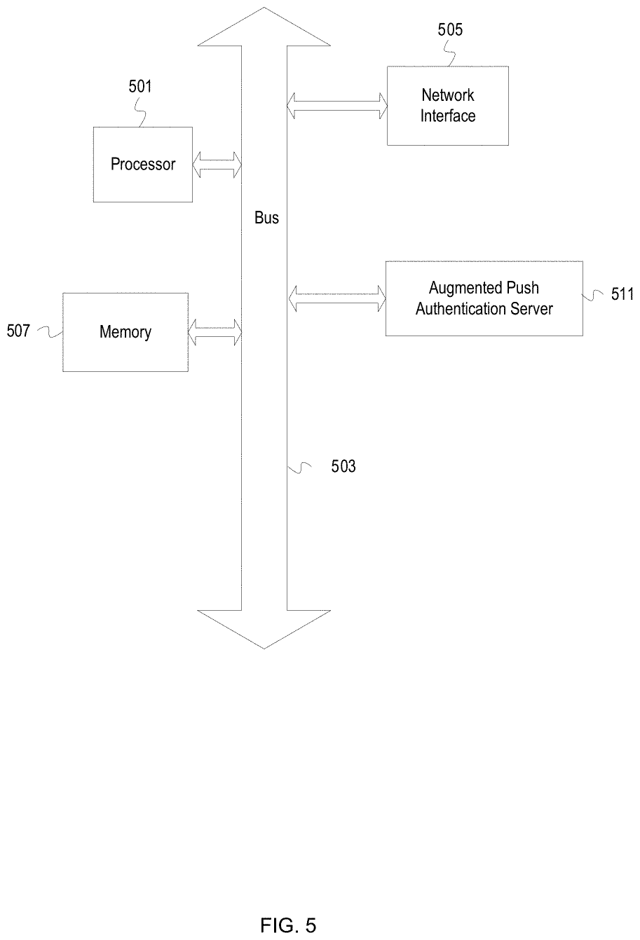

FIG. 5 depicts an example computer system with an augmented push authentication server. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505 (e.g., a wired and/or wireless interface). The system also includes an augmented push authentication server 511. The augmented push authentication server 511 merges or folds a “what you know” factor into a “what you have” factor—the what you have factor being a device that is registered to receive out-of-band push authentication messages/notifications. To fold or merge authentication factors, the server 511 selects from a list of questions for which answers have been previously collected. When building the push authentication message, the server 511 includes the selected question(s) and a display directive or parameters for displaying the question and choices as answers to the question. The server authentication based on both verifying that the registered device is responding and that the response includes the correct answer to the selected question. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

While the aspects of the disclosure are described with reference to various implementations and exploitations, it will be understood that these aspects are illustrative and that the scope of the claims is not limited to them. In general, techniques for augmented push authentication as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining that push authentication is indicated for a protected resource in response to receipt, by an authentication server from a first device, of an access request with a first authentication credential;
determining an identifier of a second device that has been registered for the push authentication for the protected resource;
selecting a first knowledge-based question from a plurality of knowledge-based questions for which answers have been previously collected and are associated with the first authentication credential;
constructing a first payload comprising the first knowledge-based question and program code indicating how to present the first knowledge-based question in a user interface of an authentication application on the second device;
constructing a push authentication message comprising the first payload and an identifier for the authentication application; and
transmitting the push authentication message to the second device.

2. The method of claim 1 further comprising extracting a first answer to the first knowledge-based question from a second payload of a response message from the second device and determining that the response message is from the first device and that the first answer matches a correct answer to the first knowledge-based question, wherein the correct answer to the first knowledge-based question is one of the answers previously collected.

3. The method of claim 2 further comprising successfully authenticating the first authentication credential based on determining that the first answer matches the correct answer and that the response message is from the second device.

4. The method of claim 2, wherein determining that the response message is from the second device comprises determining that the response message includes a security value communicated to the second device in the push authentication message.

5. The method of claim 4, wherein the security value is one of a cryptographic value generated by the authentication server and a cryptographic value generated by the authentication application and previously communicated to the authentication server.

6. The method of claim 1, wherein selecting a first knowledge-based question from a plurality of knowledge-based questions comprises randomly selecting from the plurality of knowledge-based questions.

7. The method of claim 1 further comprising determining a plurality of incorrect answers to the first knowledge-based question, wherein constructing the first payload further comprises constructing the first payload with the plurality of incorrect answers and a correct answer and the program code to also indicate how to present the plurality of incorrect answers and the correct answer in the user interface of the authentication application.

8. The method of claim 1 further comprising determining a plurality of incorrect answers to the first knowledge-based question, wherein constructing the first payload further comprises constructing the first payload with the plurality of incorrect answers and a correct answer at a lower resolution and the program code to also indicate how to present the plurality of incorrect answers and the correct answer in the user interface of the authentication application, wherein the plurality of incorrect answers are at a same resolution as the lower resolution of the correct answer.

9. A non-transitory, computer-readable medium having instructions stored thereon that are executable by a computing device to perform operations comprising:
determining an identifier of a device that has been registered for push authentication corresponding to an application based on detecting a login request for the application;
selecting a first question from a plurality of questions, wherein answers have been previously collected based on push authentication registration;
constructing a first payload comprising the first question;
constructing a message comprising the first payload and the identifier of the device that has been registered; and
transmitting the message to the device.

10. The non-transitory, computer-readable medium of claim 9 further comprising constructing the message with a token to validate a response to the message.

11. The non-transitory, computer-readable medium of claim 10, wherein the token corresponds to the application.

12. The non-transitory, computer-readable medium of claim 9, wherein constructing the first payload further comprises constructing the first payload with program code to indicate how to present the first question in a target application on the device and with an identifier of the target application.

13. The non-transitory, computer-readable medium of claim 9 further comprising instructions stored thereon that are executable by a computing device to perform operations comprising determining a plurality of incorrect answers to the first question, wherein constructing the first payload further comprises constructing the first payload with the plurality of incorrect answers, a correct answer, and program code to indicate how to present the answers in a target application on the device.

14. The non-transitory, computer-readable medium of claim 9 further comprising instructions stored thereon that are executable by a computing device to perform operations comprising:
determining an answer resolution level; and
determine a correct answer to the first question at the answer resolution level and incorrect answers at the answer resolution level;
wherein constructing the first payload further comprises constructing the first payload with the incorrect answers and the correct answer at the answer resolution level and with program code that instructs a target application on the device how to present the answers in a user interface of the target application.

15. The non-transitory, computer-readable medium of claim 9, wherein selecting a first question comprises randomly selecting from the plurality of questions.

16. An apparatus comprising:
a processor; and
a computer-readable medium having instructions stored thereon that are executable by the processor to cause the apparatus to,
determine that multi-factor authentication for a protected resource requires an augmented push authentication that merges the what you know and what you have factors;
determine a registered device associated with an authentication credential indicated in login request for the protected resource;
select a first question from a plurality of questions, wherein answers to the plurality of questions have been previously collected based on registration for the augmented push authentication;
construct a message comprising identification of an application, the first question, and program code to indicate user interface parameters for the application to present the first question and collect an answer; and
transmit the message to the registered device.

17. The apparatus of claim 16, wherein the computer-readable medium further has stored thereon instructions executable by the processor to cause the apparatus to determine a correct answer and a plurality of incorrect answers to the first question, wherein the instructions to construct the message further comprise instructions executable by the processor to cause the apparatus to construct the message with the answers and program code to indicate additional user interface parameters for the application to present the answers on the registered device.

18. The apparatus of claim 16, wherein the computer-readable medium further has stored thereon instructions executable by the processor to cause the apparatus to:
determine an answer resolution level; and
determine a correct answer to the first question at the answer resolution level and incorrect answers at the answer resolution level;
wherein the instructions to construct the message comprise instructions to construct the message with the incorrect answers and the correct answer at the answer resolution level and with program code that instructs the application how to present the answers in a user interface.

19. The apparatus of claim 16, wherein the instructions to select a first question comprises randomly selecting from the plurality of questions.

20. The apparatus of claim 16, wherein the computer-readable medium further has stored thereon instructions executable by the processor to cause the apparatus to extract a first collected answer to the first question from a response message and verify that the response message is from the registered device and that the first collected answer matches a correct answer to the first question, wherein the correct answer to the first question is one of the answers previously collected.
